(19) United States
(12) Patent Application Publication
(10) Pub. No.: US 2023/0403531 A1
(43) Pub. Date: Dec. 14, 2023

(54) SYSTEMS AND METHODS FOR SENDING A FIRST USERS INFORMATION TO A SECOND USER

(71) Applicants: Dwain Wright, Elverson, PA (US); Maureen Tully, Elverson, PA (US)

(72) Inventors: Dwain Wright, Elverson, PA (US); Maureen Tully, Elverson, PA (US)

(21) Appl. No.: 17/836,534

(22) Filed: Jun. 9, 2022

(51) Int. Cl. H04W 4/029; H04W 4/02; H04L 67/306; H04W 4/20

(52) U.S. Cl. CPC H04W 4/029; H04W 4/023; H04L 67/306; H04W 4/20

(57) ABSTRACT

A system and methods for facilitation the sending of a first user's information from a first user device to a second user device is provided. The system includes a first user device, a second user device, and an intermediary server device communicatively coupled to the first user device and to the second user device. The first user device may relate to a first user and the second user device may relate to a second user. The server device may determine that the first user device and second user device are within a predetermined distance of one another. The first user device and the second user device may collect and send biometric or other user identifier information to the server device. When the first user updates a first user profile, other users with access to the first user profile may automatically have their version of the first user profile be updated.

### BRIEF SUMMARY OF INVENTION

The possible implementations described herein generally relate to systems and methods that facilitate the sending of personal information from a first user to a second user.

According to some possible implementations, the information sending system includes a first user device having an application installed and a second user device having an application installed. The application can take the form of one or more computer programs or software instructions.

In some possible implementations, the tools and functions of the application may include, without limitation, a nearby user search tool that displays a list of other users within a predetermined distance, a contacts list, a user profile settings page, and a user settings page.

According to some possible implementations, the first user device and second user device have a global positioning system (GPS) tracking system.

According to some possible implementations, the first user device and second user device further have a fingerprint reading system and a fingerprint recognition system.

According to some possible implementations, the first user device and second user device further have a facial recognition system.

According to some possible implementations, the first user device further includes a first contacts list and the second user device further includes a second contacts list.

According to some possible implementations, the first user device further includes one or more first user profiles, including a first public profile and one or more first private profiles.

According to some possible implementations, the second user device further includes one or more second user profiles, including a second public profile and one or more second private profiles.

According to some possible implementations, a public profile contains a user's information that they wish to be publicly accessible. Information contained within a public profile can be visible to other nearby users via the application's nearby user search tool. A private profile contains a user's information that they wish to be accessible only to other users with who they have previously shared access to that private profile. Users can customize which information is contained within their public profile and their one or more private profile(s).

According to some possible implementations, the system further includes a server device having a processor, a memory, and one or more programs stored within memory for facilitating the exchange of information between two or more user devices. The server device can be communicatively coupled to the first user device via the installed application and to the second user device via the installed application.

According to some possible implementations, when the one or more programs stored within the server device's memory are run on the processor, the server device is configured to receive personal information from the first user device and the second user device. The received personal information from both devices can be stored in the server's memory.

According to some possible implementations, the server device is a web server.

According to some possible implementations, the server device is a cloud server.

According to some possible implementations, when the server device is coupled to a user device, the server device periodically receives GPS coordinates relating to the position of the user device.

According to some possible implementations, when a first user device is communicatively coupled to the server device, the first user device receives from the server device and displays to the first user, a list of other nearby user devices within a predetermined distance from the first user device. The user devices included in the list of other nearby user devices are communicatively coupled to the server device. The first user can then select a second user device from the list to view the second public profile. The first user can then request to send a first public profile or a first private profile to the second user device. The second user can then choose to accept or reject the first user's request. If the second user chooses to accept the first user's request, then the server device sends the most up-to-date first user's selected public or private profile information to the second user device and the first user's contact information is added to the second contacts list.

According to some possible implementations, once the first user sends a request to send a first user profile to the second user device, the request will remain visible until it is either accepted or rejected by the second user, even if the second user device is no longer communicatively coupled with the server device or the second user device is further than the predetermined distance away from the first user device.

According to some possible implementations, the processes described above further include a contacts list information synchronization process which works as follows: whenever a first user updates a first public profile or a first private profile and the first user device is then communicatively coupled to the server device, the updated first public/private profile information is sent to the server device and stored as the first user's most up-to-date information for that first public/private profile. Any other user devices with which the first user had previously shared the recently updated first public/private profile will have the first public/private profile information stored on their device synchronized to match the most up-to-date first public/private profile information stored on the server device.

According to some possible implementations, a server device may receive a plurality of identifying user information from a user device.

According to some possible implementations, a server device may receive and store a plurality of first identifying information from a first user device. One or more first user profiles may be associated with a unique plurality of first identifying information.

According to some possible implementations, the plurality of first identifying information may relate to the first user's biometric fingerprint.

According to some possible implementations, the plurality of first identifying information may relate to the first user's biometric facial identifiers.

According to some possible implementations, a first user profile can be shared with a second user device as follows. A second user device is first communicatively coupled to the server device. A first user then uses the second user device to send a plurality of identifying user information to the server device. The server device then identifies the one or more first user profiles associated with the plurality of identifying user information. The server device then sends a list of the identified one or more first user profiles to the second user device. The first user then can select which one or more first user profiles from the list they wish to share with the second user. The first user's selection is then sent to the server device. The server device then sends the one or more first user profiles relating to the first user's selection to the second user device. The second user device then receives the selected one or more first user profiles and the first user's contact information is added to the second contacts list.

### BRIEF DESCRIPTION OF THE DRAWINGS

FIGS. 1A-1B are diagrams of an example implementation in which systems and/or methods, described herein, may be implemented.

FIG. 2 is a flow chart of an example process for sending information from a first user device to a second user device.

FIG. 3 is a flow chart of an example process for sending a first user's information to a second user device.

FIG. 4 is a flow chart of an example process for shared information synchronization.

FIG. 5 is a diagram of example components of a computing device.

### DETAILED DESCRIPTION

The following detailed description of example implementations refers to the accompanying drawings. The same reference numbers in different drawings may identify the same or similar elements.

Some implementations, described herein, provide an information sending platform that is capable of facilitating a sending of information (e.g., personal information, social media information, and/or the like) between a first user and a second user. The first user and the second user utilize computing devices, including but not limited to, smartphones, tablets, laptop computers, and desktop computers. A computing device utilized by the first user is herein referred to as a first user device. A computing device utilized by the second user is herein referred to as a second user device.

In some possible implementations, the information sending system includes joining software. The joining software may take the form of one or more computer programs or software applications (hereinafter referred to as “application” or “applications”). In some possible implementations, an application is configured to run on the first user device and may be downloaded and installed on the first user device. In some possible implementations, an application is configured to run on the second user device and may be downloaded and installed on the second user device.

In some possible implementations, the tools and functions of the application may include, without limitation, a nearby user search tool that displays a list of other users within a predetermined distance, a contacts list that lists other users (contacts) that have previously shared their user profiles with the user device, a user profile settings page that allows a user to configure their public profile and their one or more private profiles, and a user settings page that allows a user to configure general application settings. Selecting a contact from the contacts list will display user profiles associated with that contact that have been previously shared with the user.

In some possible implementations, the information sending system includes a server device that includes one or more processors, memory, and a program for sending information from a first user device to a second user device. The server device can be readily communicatively coupled to a first user device and to a second user device. In some possible implementations, the communicative coupling between the server device and the user devices is facilitated by the application installed on the user devices. In some possible implementations, the server device is a physical web server. In some possible implementations, the server device is a cloud server that performs all the same functions of the traditional physical server, including but not limited to, delivering processing power, storage, and applications.

In some possible implementations, when the information sending program is executed by one or more processors of the server device, the server device is configured to receive information from a first user device and from a second user device, to store the received information in the server's memory, and to send information to the first user device and to the second user device.

As used herein, the term component is intended to be broadly construed as hardware, firmware, or a combination of hardware and software.

No element, act, or instruction used herein should be construed as critical or essential unless explicitly described as such.

Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” and/or the like are intended to be open-ended terms.

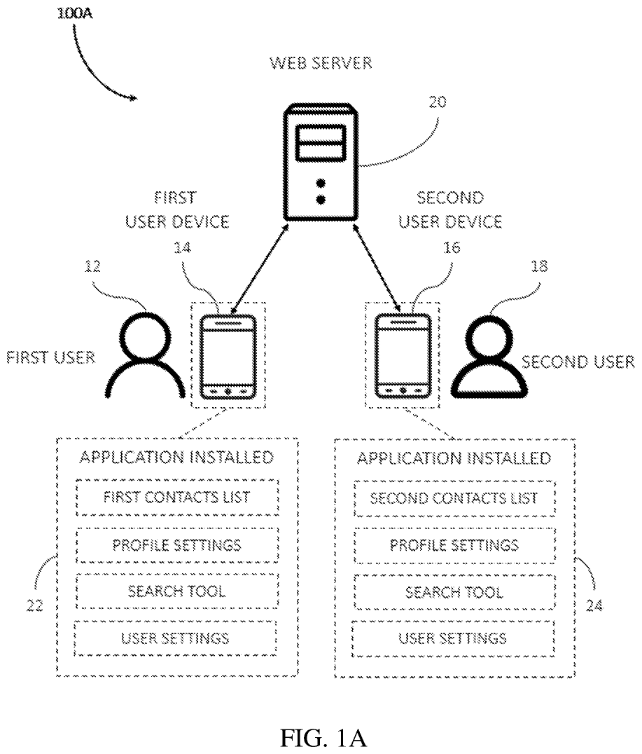

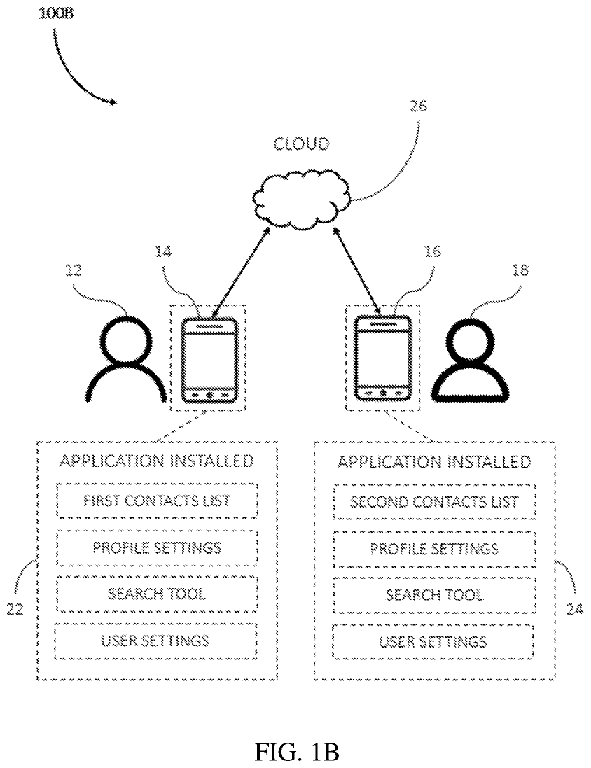

FIG. 1A is a diagram of an example environment 100A in which systems and/or methods, described herein, may be implemented. As shown in FIG. 1, the example environment 100A includes a first user 12, a first user device 14, a web server 20, a second user device 16, and a second user 18. The first user device is associated with the first user and the second user device is associated with the second user. The first user device has an application 22 installed. The application 22 as installed on the first user device includes, but is not limited to, a first contacts list, a profile settings page, a nearby user search tool, and a user settings page. Similarly, the second user device has an application 24 installed. The application 24 as installed on the second user device includes, but is not limited to, a second contacts list, a profile settings page, a nearby user search tool, and a user settings page. The software applications 22, 24 further include, without limitation, a set of tools for communicatively coupling and interacting with the web server 20. The web server 20 has a memory and one or more processors capable of running one or more programs.

The first user device 14 can thus be communicatively coupled with the web server 20. The second user device 16 can thus be communicatively coupled with the web server 20. A person skilled in the art would appreciate that a plurality of technologies and methods may be used to connect the first user device and the second user device to a server device such that the server device provides the service for sending a first user's information from the first user device to the second user device. For example, the first user device 14 may provide, to the server device 20, data relating to the first user's personal information that the first user 12 intends to send to the second user device 16, wherein the server device 20 is configured to receive such data from the first user device 14, to store such data in the server device's memory, and to send such data to the second user device 16.

FIG. 1B is another diagram of an example environment 100B in which systems and/or methods, described herein, may be implemented. Example environment 100B is identical to example environment 100A except that the server device is a cloud server 26 rather than the web server.

Computing devices of the aforementioned environments 100A, 100B may interconnect via wired connections, wireless connections, or a combination of wired and wireless connections. In some possible implementations, computing devices of the aforementioned environments 100A, 100B may interconnect with a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices shown in FIG. 1A and FIG. 1B are provided as an example. In practice, there may be additional devices and/or networks, fewer devices and/or networks, different devices and/or networks, or differently arranged devices and/or networks than those shown in FIG. 1A and FIG. 1B. Furthermore, two or more devices shown in FIG. 1A or FIG. 1B may be implemented within a single device, or a single device may be implemented as multiple, distributed devices. Additionally, or alternatively, a set of devices (e.g., one or more devices) of the aforementioned environments 100A, 100B may perform one or more functions described as being performed by another set of devices of environment.

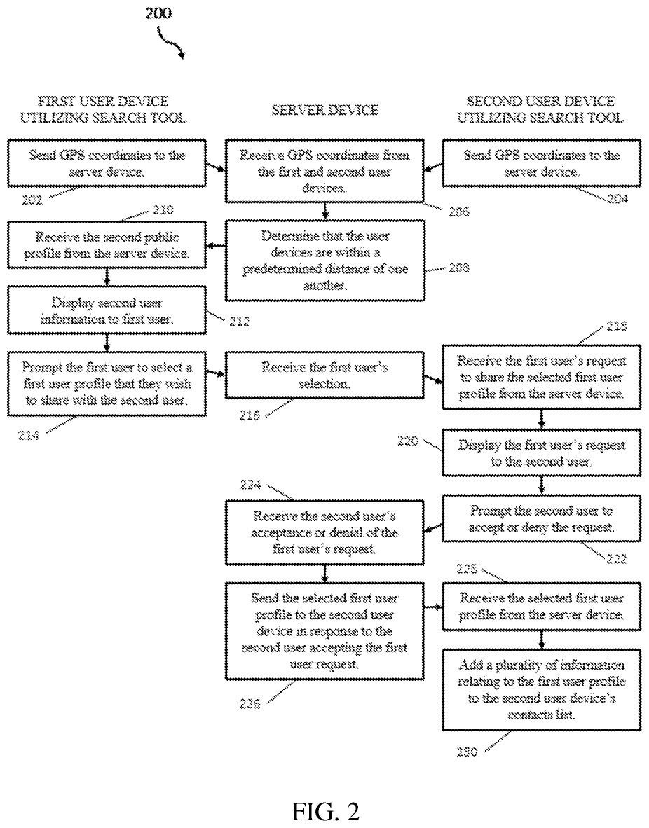

FIG. 2 is a flow chart of an example process for sending information from a first user device to a second user device using a server device to coordinate the sending of information 200. First, the first user device sends a first set of GPS coordinates relating to the physical location of the first user device to the server device 202. Similarly, the second user device sends a second set of GPS coordinates relating to the physical location of the second user device to the server device 204. The server device receives the first set of GPS coordinates from the first user device and the second set of GPS coordinates from the second user device 206. The server device then determines, based on the two sets of received GPS coordinates, whether the first user device and the second user device are within a predetermined distance of one another. The predetermined distance can be any reasonable distance for determining two user devices are in close proximity of one another using GPS coordinates, including but not limited to, 100 meters. If the server device determines that the first user device and second user device are within a predetermined distance of one another 208, the server device sends the second public profile of the second user to the first user device. The first user device receives the second public profile from the server device 210. A plurality of information found within the second public profile is displayed to the first user via a display surface of the first user device 212. Based on the displayed plurality of information, the first user can identify and select the second user as the first user's desired recipient of a first user profiles. The first user device then visually prompts the first user to select the first user profile that they desire to share with the second user 214. The first user device sends information relating to the first user's selection of which first user profile the first user desires to share with the second user to the server device. The server device receives this selection information 216. The server device then sends the first user's request to share the selected first user profile to the second user device. The second user device receives the first user's request 218. The second user device then displays the first user's request via a display surface of the second user device 220. The second user device then visually prompts the second user to accept or deny the first user's request 222. In response to the second user accepting or denying the first user's request, the second user device sends information relating to the second user's acceptance or denial to the server device. The server device receives this information relating to the second user's acceptance or denial 224. If the second user denies the first user's request, no further action is taken and this process ends. If the second user accepts the first user's request, then the server device sends the first user profile relating to the first user's selection to the second user device 226. The second user device receives the first user profile from the server device 228. The second user device then adds a plurality of information relating to the received first user profile to the second user device's contacts list as a new contacts list entry.

After a plurality of information relating to the received first user profile has been added to the second user device's contacts list as a new contacts list entry, the second user can enter the second contacts list tool, find and select the contacts list entry associated with the first user, and view any first public profile or one or more first private profiles that the first user previously shared with the second user. If the second contacts list already includes the first user, a new contacts list entry into the second contacts list will not be made. However, any previously unshared first user profiles corresponding to the first user's selection will now be available for viewing by the second user.

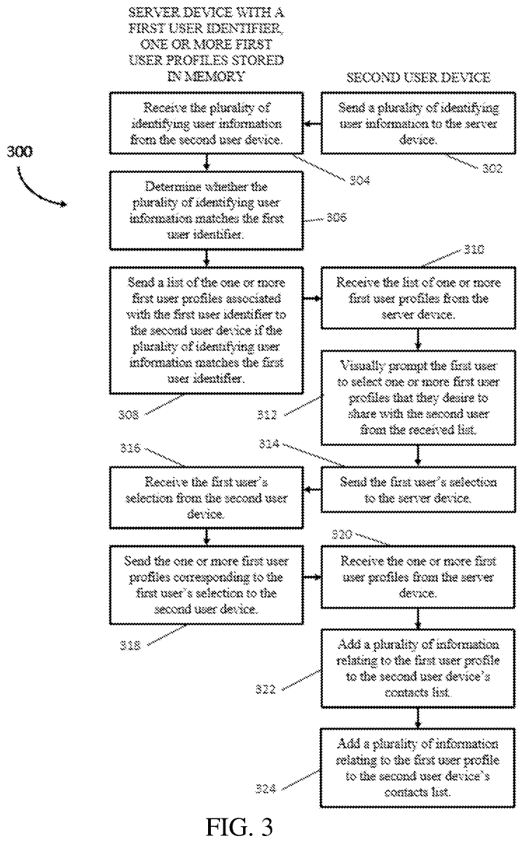

FIG. 3 is a flow chart of an example process for sending a first user's information to a second user device 300. Using this method, a first user wishing to share their information with a second user only needs access to the second user's user device. First, the first user uses the second user device to send a plurality of identifying user information to a server device 302. The plurality of identifying user information may relate to the first user's unique biometric information such as a biometric fingerprint, a biometric face scan, and the like. The plurality of identifying user information may further relate to the first user's unique pin code or password associated with the first user's identity. In some possible implementations, a user may select which type of identifying user information they desire to identify themselves with (e.g., pin code, biometric fingerprint). The server device has stored within the server device's memory a database containing unique user identifiers each corresponding to a unique user (e.g., a list of unique pin codes, a list of data associated with unique biometrics). The server device further has stored within the server device's memory information corresponding to a plurality of user profiles associated with a plurality of unique users. In some possible implementations, the server device further has stored within the server device's memory a relational database which links unique user identifiers to the plurality of unique user profiles associated with that user. For example, a first user's unique user identifier, referred to herein as “first user identifier”, can be relationally linked to one or more first user's user profiles, referred to herein as “one or more first user profiles”, stored in the server device's memory. For example, and without limitation, the one or more first user profiles may include that user's public profile and four private profiles. The server device receives the plurality of identifying user information from the second user device 304. The server device then determines whether the received plurality of identifying user information matches any unique user identifiers stored within the server device's memory 306. Given a plurality of identifying user information provided by a first user, the server device would determine that the provided plurality of identifying user information matches the first user identifier relating to the first user 306. In response to the provided plurality of identifying user information matching the first user identifier, the server device would send a list of the one or more first user profiles associated with the first user identifier to the second user device 308. If no match is found, then no list containing one or more user profiles will be sent. The second user device receives the list of one or more first user profiles from the server device. The second user device then visually prompts the first user to select one or more first user profiles that they desire to share with the second user from the received list 312. The second user device then sends the information relating to the first user's selection to the server device 314. The server device receives the information relating to the first user's selection from the second user device 316. In response to receiving the information relating to the first user's selection, the server device sends the one or more first user profiles corresponding to the first user's election to the second user device 318. The second user device receives the one or more first user profiles from the server device 320. The second user device then adds a plurality of information relating to the one or more received first user profiles to the second user device's contacts list as a new contacts list entry 324.

After a plurality of information relating to the received first user profile has been added to the second user device's contacts list as a new contacts list entry, the second user can then enter the second contacts list tool, find and select the contacts list entry associated with the first user, and view any first public profile or one or more first private profiles that the first user previously shared with the second user. If the second contacts list already includes the first user, a new contacts list entry into the second contacts list will not be made. However, any previously unshared first user profiles corresponding to the first user's selection will now be available for viewing by the second user.

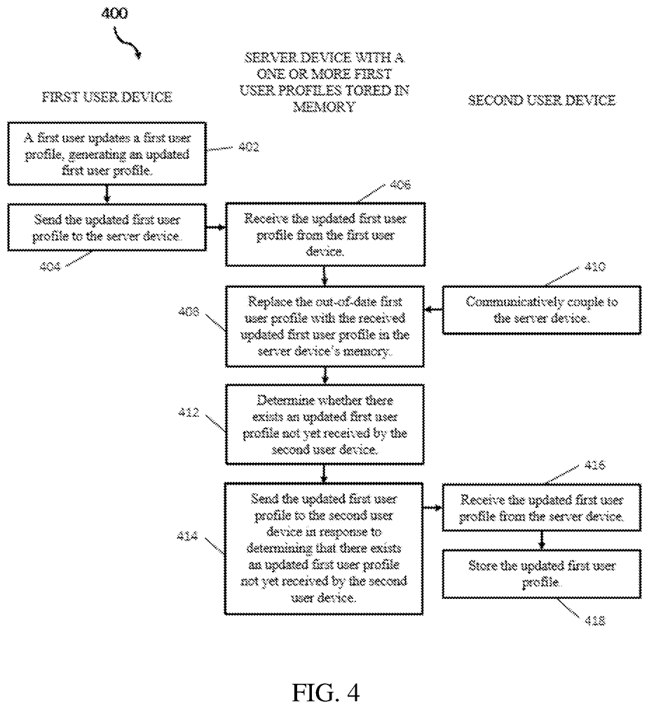

FIG. 4 is a flow chart of an example process for shared information server device synchronization 400. First, a first user updates a first user profile using the profile settings tool of the application, generating an updated first user profile 402. The first user device then sends the updated first user profile to the server device 404. The server device receives the updated first user profile from the first user device 406. The server device replaces the out-of-date first user profile corresponding to the received updated first user profile with the received updated first user profile in the server device's memory 408. An arbitrary amount of time after these previous steps have occurred, the second user device communicatively couples to the server device 410. In some possible implementations, such communicative coupling between the second user device and the server occurs when a second user opens the application. In some possible implementations, such communicative coupling between the second user device and the server occurs passively and periodically, via an internet connection or mobile service connection. After coupling has occurred, the server device determines whether there exists and updated first user profile not yet received by the second user device 412. The server device then sends the updated first user profile to the second user device in response to determining that there exists an updated first user profile not yet received by the second user device 414. The second user device receives the updated first user profile from the server device 416. The updated first user profile is stored on the second user device 418 and is then accessible by the second user via the second contacts list.

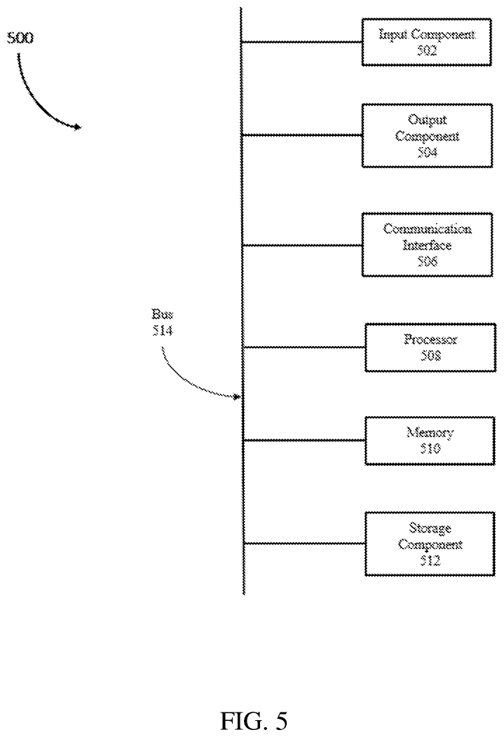

FIG. 5 is a diagram of example components of a computing device 500. Computing device 500 may correspond to first user device 14, second user device 16, web server 20, and/or cloud server 26. In some implementations, user devices 14, 16 and/or server device 20, 26 may include one or more devices 500 and/or one or more components of device 500. As shown in FIG. 5, device 500 may include an input component 502, an output component 504, a communication interface 506, a processor 508, a memory 510, a storage component 512, and a bus 514.

The bus 514 includes a component that permits communication among the components of device 500. Processor 508 is implemented in hardware, firmware, or a combination of hardware and software. Processor 508 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 508 includes one or more processors capable of being programmed to perform a function. Memory 510 includes a random access memory (RAM), a read only memory (ROM), and/or another type of dynamic or static storage device (e.g., a flash memory, a magnetic memory, and/or an optical memory) that stores information and/or instructions for use by processor 508.

Storage component 512 stores information and/or software related to the operation and use of device 500. For example, storage component 512 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 502 includes a component that permits device 500 to receive information, such as via user input (e.g., a touch screen display, a keyboard, a keypad, a mouse, a button, a switch, and/or a microphone). Additionally, or alternatively, input component 502 may include a sensor for sensing information (e.g., a global positioning system (GPS) component, an accelerometer, a gyroscope, and/or an actuator). Output component 504 includes a component that provides output information from device 500 (e.g., a display, a speaker, and/or one or more light-emitting diodes (LEDs)).

Communication interface 506 includes a transceiver-like component (e.g., a transceiver and/or a separate receiver and transmitter) that enables device 500 to communicate with other devices, such as via a wired connection, a wireless connection, or a combination of wired and wireless connections. Communication interface 506 may permit device 500 to receive information from another device and/or provide information to another device. For example, communication interface 506 may include an Ethernet interface, an optical interface, a coaxial interface, an infrared interface, a radio frequency (RF) interface, a universal serial bus (USB) interface, a wireless local area network interface, a cellular network interface, and/or the like.

Device 500 may perform one or more processes described herein. Device 500 may perform these processes based on processor 508 executing software instructions stored by a non-transitory computer-readable medium, such as memory 510 and/or storage component 512. A computer-readable medium is defined herein as a non-transitory memory device. A memory device includes memory space within a single physical storage device or memory space spread across multiple physical storage devices.

Software instructions may be read into memory 510 and/or storage component 512 from another computer-readable medium or from another device via communication interface 506. When executed, software instructions stored in memory 510 and/or storage component 512 may cause processor 508 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

We claim:

1. A method of sending information, comprising:
receiving, by a server device having a memory and one or more processors and from a first user device communicatively coupled to the service device, a first set of GPS coordinates, and from a second user device communicatively coupled to the service device, a second set of GPS coordinates,
the first set of GPS coordinates relating to the physical location of the first user device,
the second set of GPS coordinates relating to the physical location of the second user device,
the first user device relating to a first user and having a first contacts list and first user profiles, the first user profiles including a first public profile and one or more first private profiles,
the second user device relating to a second user and having a second contacts list and second user profiles, the second user profiles including a second public profile and one or more second private profiles,
the server's memory containing the first user profiles and the second user profiles;
determining, by the server, whether the first user device and the second user device are within a predetermined distance of one another;
in response to determining that the first user device and the second user device are within the predetermined distance of one another:
by the server device:
sending the second public profile to the first user device;
by the first user device:
receiving the second public profile from the server device;
displaying some or all of the second public profile to the first user;
visually prompting the first user to select a first user profile that they wish to share with the second user;
sending the first user's selection to the server device;
by the server device:
receiving the first user's selection from the first user device;
sending a first request to accept the first user profile to the second user device;
by the second user device:
receiving the first request from the server device;
displaying the first request to the second user;
visually prompting the second user to accept or deny the first request;
in response to the second user accepting the first request:
sending the second user's acceptance to the server device;
by the server device:
receiving the second user's acceptance of the first request from the second user device; and
sending the first user profile relating to the first user's selection to the second user device.

2. The method of claim 1, further comprising:
by the second user device:
receiving the first user profile relating to the first user's selection from the server device; and
adding a plurality of information relating to the first user profile to the second contacts list.

3. The method of claim 2, further comprising:
in response to the first user updating a first user profile resulting in an updated first user profile:
by the first user device:
sending the updated first user profile to the server device;
by the server device:
receiving the updated first user profile; and
storing the updated first user profile in the memory.

4. The method of claim 3, further comprising:
by the second user device:
communicatively coupling to the server device;
by the server device:
determining whether there exists an updated first user profile not yet received by the second user device;
in response to determining that there exists an updated first user profile not yet received by the second user device:
sending the updated first user profile to the second user device;
by the second user device:
receiving the updated first user profile; and
storing the updated first user profile.

5. A non-transitory computer-readable medium storing instructions for sending information from a first user device to a second user device, the instructions comprising:
one or more instructions that, when executed by one or more processors of a server device, cause the one or more processors to:
receive, from the first user device communicatively coupled to the server device, a first set of GPS coordinates, and from the second user device communicatively coupled to the server device, a second set of GPS coordinates,
the first set of GPS coordinates relating to the physical location of the first user device,
the second set of GPS coordinates relating to the physical location of the second user device,
the first user device relating to a first user and having a first contacts list and first user profiles, the first user profiles including a first public profile and one or more first private profiles;
the second user device relating to a second user and having a second contacts list and second user profiles, the second user profiles including a second public profile and one or more second private profiles;
the server's memory containing the first user profiles and the second user profiles;
determine whether the first user device and the second user device are within a predetermined distance of one another;
in response to determining that the first user device and the second user device are within a predetermined distance of one another;
send the second public profile to the first user device;
receive a selected first user profile from the first user device;
send a first request to accept the selected first user profile to the second user device for the second user to accept or reject;
receive a second user's acceptance of the first request from the second user device; and
send the selected first user profile to the second user device.

6. The non-transitory computer-readable medium of claim 5 further storing instructions comprising:
one or more instructions that, when executed by one or more processors of a server device, cause the one or more processors to:
in response to the first user updating a first user profile resulting in an updated first user profile:
receive the updated first user profile from the first user device; and
store the updated first user profile in the memory.

7. The non-transitory computer-readable medium of claim 6 further storing instructions comprising:
one or more instructions that, when executed by one or more processors of a server device, cause the one or more processors to:
communicatively couple the server device with the second user device;
determine whether there exists an updated first user profile not yet received by the second user device; and
in response to determining that there exists an updated first user profile not yet received by the second user device:
send the updated first user profile to the second user device.

8. A method of sending information, comprising:
receiving, by a server device having a memory and one or more processors and from a second user device communicatively coupled to the server device, a plurality of identifying user information,
the memory containing a plurality of unique user identifiers that includes a first user identifier which can be used to confirm the identity of a first user;
the memory containing one or more first user profiles associated with the first user identifier;
the second user device relating to a second user and having a second contacts list;
determining, by the server device, whether the plurality of user identifying information matches the first user identifier;
in response to determining that the plurality of user identifying information matches the first user identifier;
by the server device:
sending a list of the one or more first user profiles associated with the first user identifier to the second user device;
by the second user device:
receiving the list of one or more first user profiles from the server device;
displaying the list to the first user;
visually prompting the first user to select one or more first user profiles from the list;
sending the first user's selection to the server device;
by the server device:
receiving the first user's selection;
sending the one or more first user profiles corresponding to the first user's selection to the second user device;
by the second user device:
receiving the one or more first user profiles from the server device; and
adding a plurality of information relating to the one or more first user profiles to the second contacts list.

9. The method of claim 8, wherein the plurality of identifying user information is biometric fingerprint information.

10. The method of claim 8, wherein the plurality of identifying user information relates to patterns on the basis of facial contours obtained using biometric facial recognition.
